(19) United States
(12) Patent Application Publication
(10) Pub. No.: US 2025/0264660 A1
(43) Pub. Date: Aug. 21, 2025

(54) OFFLOADING PHOTONIC INTEGRATED CIRCUIT FUNCTIONALITY INTO OPTICAL INTERCONNECTS

(71) Applicant: Applied Materials, Inc., Santa Clara, CA (US)

(72) Inventors: Robert Blum, Mountain View, CA (US); Jinxin Fu, Santa Clara, CA (US); Zijiao Yang, Fremont, CA (US); Hans-Juergen Schmidtke, Mountain View, CA (US)

(21) Appl. No.: 19/057,862

(22) Filed: Feb. 19, 2025

Related U.S. Application Data
(60) Provisional application No. 63/556,092, filed on Feb. 21, 2024.

(51) Int. Cl. G02B 6/12

(52) U.S. Cl. CPC G02B 6/12004; G02B 6/12009; G02B 2006/12142; G02B 2006/12154

(57) ABSTRACT

A system includes an interconnect including at least one power splitter; and a photonic integrated circuit (PIC) disposed on the interconnect, the PIC including at least one set of modulators.

### CROSS-REFERENCE TO RELATED APPLICATION(S)

The present application claims priority to U.S. Provisional Patent Application No. 63/556,092, filed on Feb. 21, 2024 and entitled “OFFLOADING PHOTONIC INTEGRATED CIRCUIT FUNCTIONALITY ONTO OPTICAL INTERCONNECTS”, the entire contents of which are hereby incorporated by reference herein.

### TECHNICAL FIELD

Embodiments of the present disclosure relate to optical systems, and more particularly to offloading photonic integrated circuit (PIC) functionality into optical interconnects (e.g., interposers).

### BACKGROUND

A co-packaged device (e.g., multi-chip module) can include a package substrate having multiple integrated circuit devices assembled closely together. More specifically, optical components can be integrated on substrates (e.g., silicon (Si) substrate) for fabricating large-scale PICs that co-exist with micro-electronic chips. With the use of an optical transceiver, received optical signal can be converted to an electrical signal capable of being processed by an integrated circuit, or the processed electrical signal can be converted to an optical signal to be transmitted via an optical fiber.

A co-packaged device can include an interconnect device (“interconnect”) disposed between a first component and a second component. For example, an interconnect can be a placed between a package substrate and a ball grid array. In some implementations, an interconnect includes an interposer. An interposer is an electrical interface that routes connections between sockets or connections between the first component and the second component. An interposer can be used to connect components that may not naturally connect to one another.

### SUMMARY

In some embodiments, a system is provided. The system includes an interconnect including at least one power splitter; and a photonic integrated circuit (PIC) disposed on the interconnect, the PIC including at least one set of modulators.

In some embodiments, a method is provided. The method includes obtaining at least one interconnect including at least one power splitter, obtaining at least one photonic integrated circuit (PIC) including at least one set of modulators, and forming a device including the at least one interconnect and the at least one PIC.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIGS. 1A-1B are diagrams of views of an example system that can enable offloading of photonic integrated circuit (PIC) functionality into an optical interconnect, according to some embodiments.

FIGS. 2A-3 are diagram of example implementations of systems that offload photonic integrated circuit (PIC) functionality into an optical interconnect, according to some embodiments.

FIGS. 4A-4B are diagrams of example implementations of arrayed channel waveguides that can be implemented within an optical interconnect, according to some embodiments.

FIGS. 5-6C are diagrams of example implementations of waveguide routing solutions within an optical interconnect, according to some embodiments.

FIGS. 7A-10C are diagrams of views of a system including a device that can enable dense photonic waveguide (“waveguide”) to optical fiber edge coupling, according to some embodiments.

FIGS. 11A-11C are diagrams of example multimode interferometers (MMIs) that can be used to implement power splitting and combining, according to some embodiments.

FIG. 12 is a flowchart of a method to enable offloading of photonic integrated circuit (PIC) functionality into an optical interconnect, according to some embodiments.

### DETAILED DESCRIPTION

Embodiments of the present disclosure relate to offloading of photonic integrated circuit (PIC) functionality into an optical interconnect. Coupling of optical fibers to waveguides on a PIC can be implemented using an optical fiber connector (“connector”). A connector can be a single-fiber (or simplex-fiber) connector, a duplex-fiber connector, or a multi-fiber connector. Examples of types of connectors include SC (square connector) connectors, FC (ferrule connector) connectors, little or local LC (little connector or local connector) connectors, ST (straight tip) connectors, and MPO (multi-fiber push-on) connectors. One example of an MTO connector is an MTP® (multi-fiber termination push-on) connector.

A connector can include a connection substrate having multiple grooves formed therein, into which multiple respective optical fibers can be inserted and secured. Each optical fiber can be optically coupled to a respective waveguide. A connection substrate can be formed with a geometry that can provide the proper spacing to achieve optical coupling (e.g., evanescent wave coupling). For example, a large number of optical fiber-to-waveguide couplings may be needed for a multichannel wavelength division multiplexing (WDM) optical system.

One type of a connection substrate is a V-groove connection substrate, which is a substrate having multiple V-grooves formed therein. A V-groove is an opening that has a tapered shape in which the sides of the groove converged to a point (e.g., triangular shape). For each V-groove, an optical fiber can be inserted into the V-groove and secured in the V-groove using an adhesive (e.g., glue).

Some edge coupling solutions utilize single-mode fiber (SMF) to waveguide edge coupling through V-grooves. More specifically, a cladding layer can have a single-mode inner core disposed therein to form a waveguide, which can be placed in a V-groove. Such implementations cannot be densely scaled up due to limitations in cladding layer diameters. Additionally, high-speed interconnects can utilize hundreds of SMFs connected to a PIC. Individually attaching SMFs can consume a large number of spatiotemporal resources.

Typically, a PIC implementing a multichannel wavelength division multiplexing (WDM) system includes active components such as modulators, multiplexers, etc. For example, a given modulator can receive an optical wave from an optical wave source, and generate a modulated wave. A set of modulated waves generated from a set of optical waves can be combined using a respective multiplexer to generate a multiplexed wave for a given channel. Such one-to-one optical fiber-to-waveguide connections can implement many optical fiber-to-waveguide couplings for a multichannel WDM system. For example, the number of couplings can be N*M, where N is the number of optical wave sources (e.g., external light sources) and M is the number of channels of the multichannel WDM system. Accordingly, it can be difficult to scale up the number of channels in an optical system.

Aspects and implementations described herein can address these and other drawbacks by enabling offloading of PIC functionality into an optical interconnect. For example, embodiments described herein can be used to enable on-chip WDM and power splitting to reduce the number of channels (and optical fibers) designated for optical wave sources (e.g., external light sources). In some embodiments, an optical wave source is a continuous optical wave source. Reducing the number of channels designed for optical wave sources can increase bandwidth density (e.g., data flow) enabled by an optical interconnect. For example, bandwidth density can be measured in terabits per second per millimeter (Tbps/mm).

Fiber function description for N fiber coupling ports n×External laser source (ELS) backup channels (n equals the number of wavelengths in wavelength division multiplexing (WDM) or larger if the power of one individual ELS is not enough) (N-n)/2 for Rx, (N-n)/2 for Tx.

More specifically, embodiments described herein provide for various system configurations that can enable M channels of a multichannel WDM system with N wavelengths per channel.

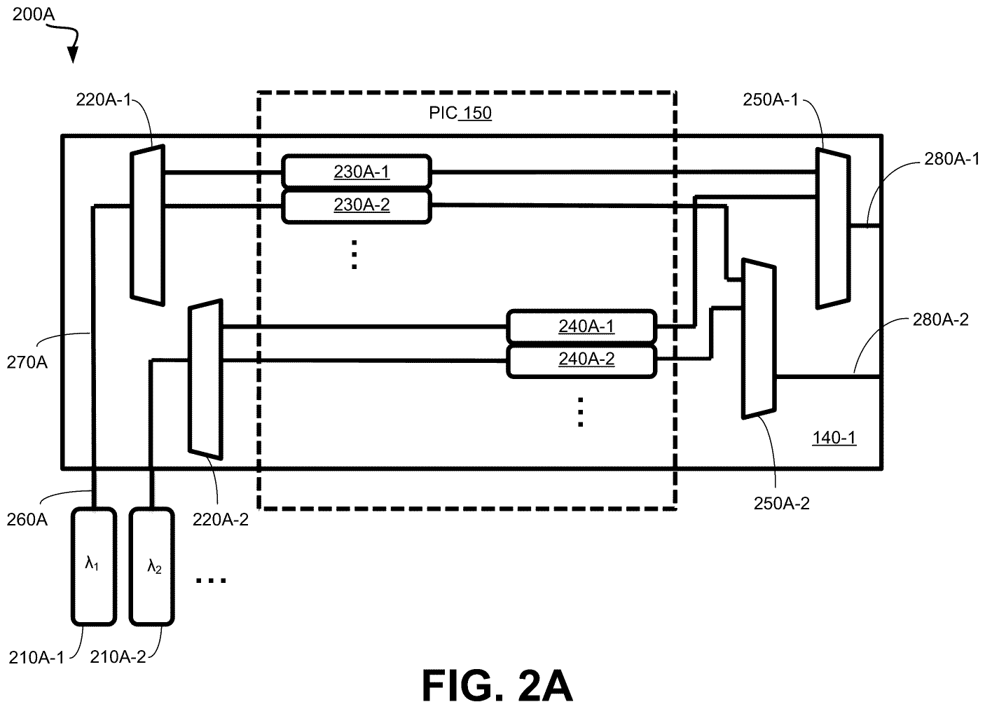

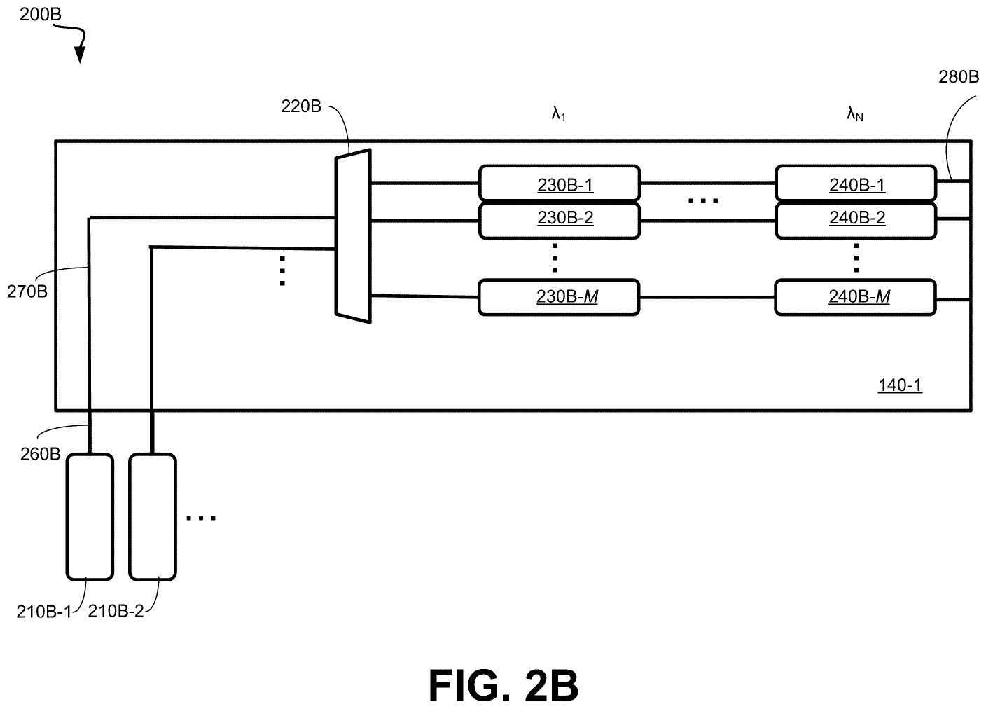

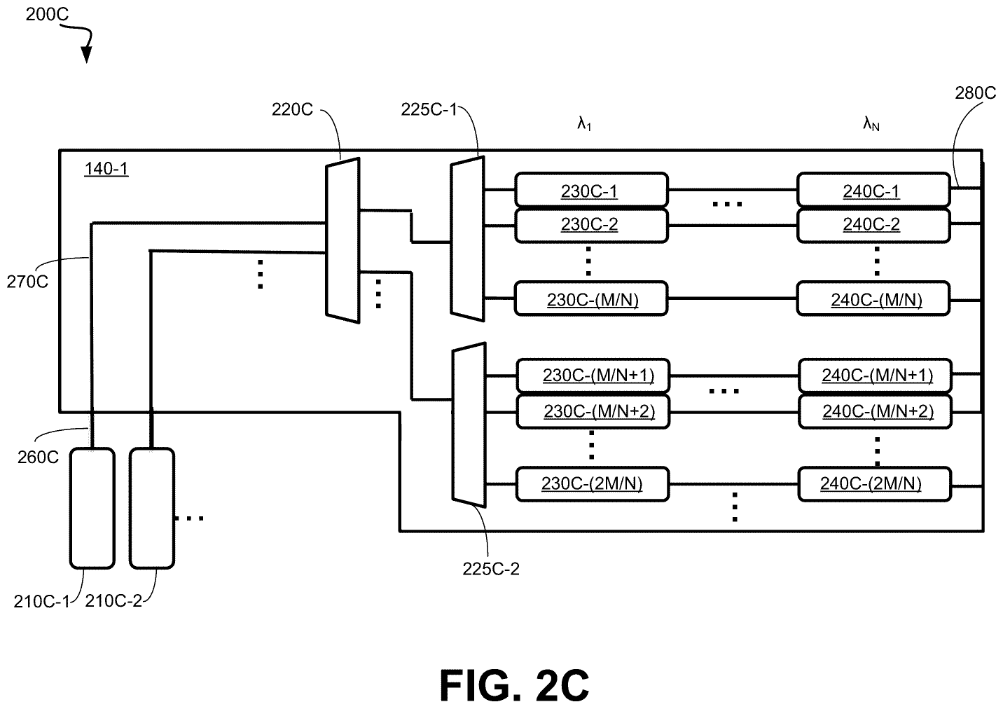

In some embodiments, a system enables M channels of a multichannel WDM system with N wavelengths per channel by implementing 1-to-M power splitting and combining. For example, the system can include N optical wave sources (e.g., external light sources) that each generate a respective wavelength of an optical wave, N 1-to-M power splitters, N sets of modulators each including M modulators, and M multiplexers. In these embodiments, each of the 1-to-M power splitters can receive a respective wavelength of an optical wave generated by the respective optical wave source, and generate M outputs (e.g., splits waves). Each of the outputs of a 1-to-M power splitter can be received by a respective modulator of a respective one of the N sets of modulators. Each modulator of a set of modulators can generate an output that is received by a respective multiplexer of the M multiplexers. This is contrast to other implementations in which a single multiplexer receives an output from each modulator of the set of modulators. An illustrative example of these embodiments will be described below with reference to FIG. 2A.

In some embodiments, a system enables M channels of a multichannel WDM system with N wavelengths per channel by implementing power splitting and combining with an N-to-M power splitter. For example, a system can include N optical wave sources (e.g., external light sources) that each generate a respective wavelength of an optical wave, an N-to-M power splitter, and N sets of modulators, where each set of modulators includes M modulators, and each set of modulators corresponds to a respective wavelength of the N wavelengths of optical waves. In these embodiments, the N-to-M power splitter can receive the N wavelengths of optical waves from the N optical wave sources, and generate M outs. Each output generated by the N-to-M power splitter can be received by a respective modulator of a set of modulators, and the respective modulator can generate an output from the split wave. An illustrative example of these embodiments will be described below with reference to FIG. 2B.

In some embodiments, a system enables M channels of a multichannel WDM system with N wavelengths per channel by implementing power splitting and combining with an N-to-N power splitter and N additional 1-to-M/N power splitters. For example, a system can include N optical wave sources (e.g., external light sources) that each generate a respective wavelength of an optical wave, an N-to-N power splitter, N additional 1-to-M/N power splitters, and N sets of modulators, where each set of modulators includes M modulators, and each set of modulators corresponds to a respective wavelength of the N wavelengths of optical waves. In these embodiments, the N-to-N power splitter can receive the N wavelengths of optical waves from the N optical wave sources, and generate N outputs. Each output generated by the N-to-N power splitter can be received by a respective one of the 1-to-M/Npower splitters. Each set of modulators can be divided into N subsets of modulators, where each subset of modulators includes N/M modulators. Each output of a 1-to-M/Npower splitter can be received by a respective modulator of a respective subset of modulators corresponding to the 1-to-M/N power splitter. An illustrative example of these embodiments will be described below with reference to FIG. 2C.

Embodiments described herein can further provide for waveguide routing solutions that can enable dense waveguide routing in a substrate in a manner that reduces (e.g., eliminates) interference. In some embodiments, a waveguide routing solution is a two-dimensional (2D) waveguide routing solution.

In some embodiments, a waveguide routing solution is a three-dimensional (3D) waveguide routing solution. A 3D waveguide routing solution can route an optical wave from a first waveguide in a first layer to a second waveguide in a second layer (e.g., above the first layer). For example, a 3D waveguide routing solution can be an evanescent coupling 3D waveguide routing solution. In this example, an optical wave from the first waveguide can be routed to the second waveguide using evanescent coupling.

As another example, a 3D waveguide routing solution can be a through via 3D waveguide routing solution. In this example, an optical wave from the first waveguide can be routed from the first waveguide to the second waveguide using a through via (e.g., through glass via (TGV) or a through silicon vias (TSV)). More specifically, a set of routing elements within the through via can be used to route the optical wave from the first waveguide to the second waveguide. For example, the set of routing elements can include a vertical waveguide, a set of optical elements (e.g., microlens, mirrors, meta-surfaces), etc.

As yet another example, a 3D waveguide routing solution can be a direct waveguide writing 3D waveguide routing solution. In this example, an optical wave generator (e.g., laser) can generate optical waves that can directly write waveguides inside of a substrate.

Embodiments described herein can implement multicore single-mode fiber (MC-SMF) to waveguide array edge coupling. An MC-SMF described herein can be connected to multiple standard SMFs with appropriate connector for standard product connection.

For example, a device described herein can include a substrate having multiple grooves (e.g., V-grooves) formed therein. The substrate can further include multiple sets of waveguides. Each set of waveguides can correspond to a respective groove of the substrate. In some embodiments, a pitch corresponding to the distance between adjacent grooves (e.g., distance between points of adjacent V-grooves) ranges between about 100 micrometers (μm) to about 150 μm. In some embodiments, the pitch is about 127 μm. Each groove can receive a respective MC-SMF optical fiber, which can be secured with an adhesive (e.g., glue). An MC-SMF optical fiber can include a cladding layer and multiple inner cores disposed within the cladding layer. Each inner core of an MC-SMF optical fiber disposed in a groove can be optically coupled to a respective waveguide of the corresponding set of waveguides formed within the substrate.

Inner cores can be arranged within a cladding layer using any suitable configuration or geometry. In some embodiments, a cladding layer has a diameter that ranges between about 100 μm to about 150 μm. In some embodiments, a cladding layer has a diameter of about 125 μm.

In some embodiments, inner cores are arranged within a cladding layer in an approximately linear configuration. In some embodiments, an inner core has a diameter that ranges between about 6 μm to about 10 μm. In some embodiments, an inner core has a diameter of about 8 μm. In some embodiments, a distance between each inner core ranges between about 15 μm to about 25 μm. In some embodiments, a distance between each inner core is about 20 μm.

In some embodiments, inner cores are arranged within a cladding layer in a non-linear configuration. For example, the non-linear configuration can have a hexagonal cross-sectional shape. The number of inner cores that can be included in a cladding layer can depend at least in part on the diameter of the cladding layer. In some embodiments, an inner core has a diameter that ranges between about 6 μm to about 10 μm. In some embodiments, an inner core has a diameter of about 8 μm.

In some embodiments, a device includes multiple substrates bonded together (e.g., vertically). More specifically, each substrate can include MC-SMF optical fibers formed in respective grooves, where each MC-SMF optical fiber includes multiple inner cores optically coupled to respective waveguides of a set of waveguides corresponding to the respective groove, similar to the substrate described above. In some embodiments, inner cores are arranged within a cladding layer in a linear configuration. In some embodiments, inner cores are arranged within a cladding layer in a non-linear configuration. For example, the non-linear configuration can have a hexagonal cross-sectional shape. Waveguides from one substrate can be routed to waveguides of another substrate using vias (e.g., through-glass vias (TGVs)), using techniques such as photonic wire bounding, meta-lens, etc.

Embodiments described herein can provide for numerous other technical advantages. For example, embodiments described herein can reduce evanescent wave decay within devices (e.g., interconnects), which can improve the ability of waveguides of these devices to transmit optical signals. Embodiments described herein can reduce the size of a PIC, which can reduce costs, and enable more PICs to be used per area on the interconnect to increase the area bandwidth density.

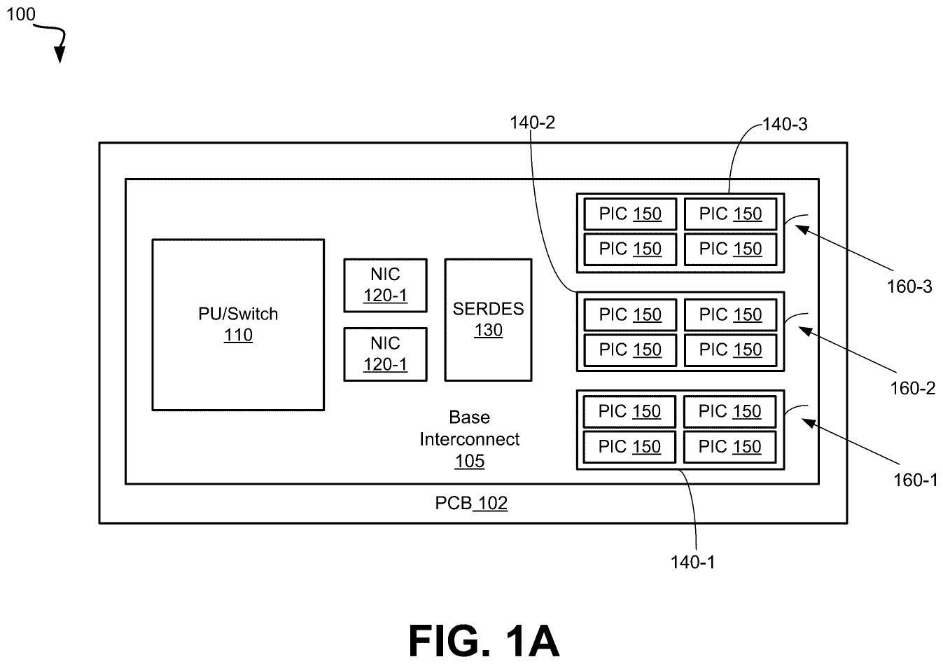

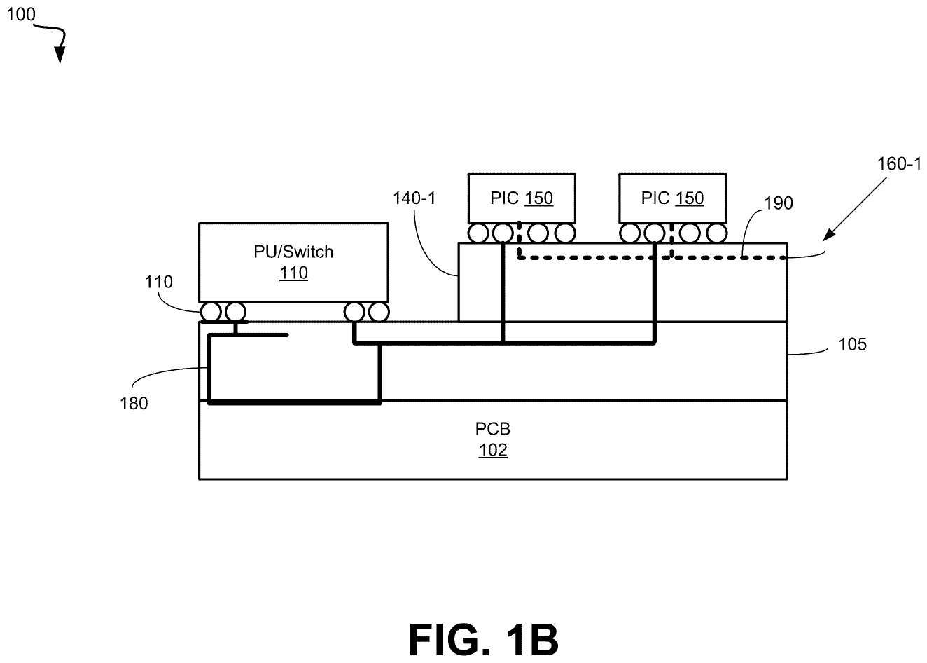

FIGS. 1A-1B are block diagrams of views of an apparatus or system 100, according to some embodiments. More specifically, FIG. 1A is a top-down view of the system 700, and FIG. 1B is a side view of the system 100.

As shown in FIG. 1A, system 100 can include printed circuit board (PCB) 102, base interconnect (e.g., interposer) 105, at least one processing unit and/or switch (PU/switch) 110 disposed on base interconnect 105, at least one network interface card (NIC) 120 disposed on base interconnect 105, serializer-deserializer (SERDES) 130 disposed on base interconnect 105, multiple supplemental interconnects 140-1 through 140-3 disposed on base interconnect 105, multiple photonic integrated circuits (PICs) 150 disposed on each of supplemental interconnects 140-1 through 140-3, and multiple waveguides 160-1 through 160-3 each coupled to a respective one of supplemental interconnects 140-1 through 140-3. In some embodiments, and as shown, the number of supplemental interconnects is three. However, the number of supplemental interconnects should not be considered limiting. In some embodiments, and as shown, each set of PICs 750s includes four PICs. However, the number of PICs should not be considered limiting.

More specifically, each of supplemental interconnects 140-1 through 140-3 can be disposed between respective sets of PICs 150 and base interconnect 105. For example, as further shown in FIG. 1B, bumps 170 are disposed between PU/Switch 110 and base interconnect 105, and between PICs 150 and supplemental interconnects 140-1 through 140-3. Conductive wires 180 can be formed through the base interconnect 705 and the supplemental interconnects 140-1 through 140-3 to enable electrical connections between components of the system 100 (e.g., PU/switch 110 and PICs 150). Additionally, through each of supplemental interconnects 140-1 through 140-3, a respective waveguide system 180 can be formed to provide optical signals to the PICs 150.

FIG. 2A is a diagram of an example system 200A, according to some embodiments. As shown, system 200A includes supplemental interconnect 140-1 and PIC 150 of FIGS. 1A-1B.

System 200A can further include multiple optical wave sources including optical wave sources 210A-1 and 210A-2. More specifically, the optical wave sources can be external optical wave sources. In some embodiments, an optical wave source is an external laser source. Each of the optical wave sources can generate a respective wavelength of an optical wave.

As further shown, system 200A can further include multiple power splitters including power splitters 220A-1 and 220A-2, multiple sets of modulators including a first set of modulators (e.g., modulators 230A-1 and 230A-2) and a second set of modulators (e.g., modulators 240A-1 and 240A-2), and multiple multiplexers including multiplexers 250A-1 and 250A-2. More specifically, the power splitters and the multiplexers can be integrated within supplemental interconnect 140-1, and the modulators are integrated within PIC 150.

Each optical wave source can be coupled to a respective power splitter. For example, optical wave source 210A-1 can be coupled to power splitter 220A-1 and optical wave source 210A-2 can be coupled to power splitter 220A-2. More specifically, each optical wave source can be connected to an optical fiber that can be coupled to a waveguide that can be connected to the respective power splitter. For example, optical fiber 260A, connected to optical wave source 210A-1, can be coupled to waveguide 270A, and waveguide 270A can be connected to power splitter 220A-1.

Each power splitter can generate multiple split waves from the respective optical wave, and each split wave can be received by a respective modulator of a respective set of modulators. For example, power splitter 220A-1 can generate multiple split waves from an optical wave generated by optical wave source 210A-1, and each split wave generated by power splitter 220A-1 can be received by a respective modulator of the first set of modulators. As another example, power splitter 220A-2 can generate multiple split waves from an optical wave generated by optical wave source 210A-2, and each split wave generated by power splitter 220A-2 can be received by a respective modulator of the second set of modulators.

Each modulated wave generated by a modulator can be received by a respective multiplexer of the multiple multiplexers to generate a respective multiplexed wave. For example, multiplexer 250A-1 can receive the modulated wave generated by modulator 230A-1 of the first set of modulators, the modulated wave generated by modulator 240A-1 of the second set of modulators, etc. As another example, multiplexer 250A-2 can receive the modulated wave generated by modulator 230A-2 of the first set of modulators, the modulated wave generated by modulator 240A-2 of the second set of modulators, etc.

Each multiplexed wave can correspond to a respective channel of a multichannel WDM system. For example, the multiplexed wave generated by multiplexer 250A-1 can correspond to channel 280A-1, and the multiplexed wave generated by multiplexer 250A-2 can correspond to channel 280A-2.

FIG. 2B is a diagram of an example system 200B, according to some embodiments. As shown, system 200B can include supplemental interconnect 140-1.

System 200B can further include multiple optical wave sources including optical wave sources 210B-1 and 210B-2. More specifically, the optical wave sources can be external optical wave sources. In some embodiments, an optical wave source is an external laser source. The number of optical wave sources can be equal to N. Each of the optical wave sources can generate a respective wavelength of an optical wave.

System 200B can further include power splitter 220B, and multiple sets of modulators including a first set of modulators 230B-1 through 230B-M and an N-th set of modulators 240B-1 through 240B-M. The set of modulators 230B-1 through 230B-M can correspond to a first wavelength of an optical wave (λ₁). The set of modulators 240B-1 through 240B-M can correspond to an N-th wavelength of an optical wave (λ_{N}). In some embodiments, power splitter 220B is integrated within supplemental interconnect 140-1, and the modulators are integrated within a PIC (e.g., the PIC 150 of FIGS. 1A-1B).

Each optical wave source can be coupled to power splitter 220B. More specifically, each optical wave source can be connected to an optical fiber that is coupled to a waveguide that is connected to power splitter 220B. For example, optical fiber 260B, connected to optical wave source 210B-1, can be coupled to waveguide 270B, and waveguide 270B can be connected to power splitter 220B. Power splitter 220B can be an N-to-M splitter that generates M split waves from N optical waves received from the N optical wave sources including optical wave source 210B-1 and optical wave source 210B-2.

Each of the M split waves can be received by a respective modulator of the set of modulators 230B-1 through 230B-M. Each output of a modulator of the set of modulators 230B-1 through 230B-M can be received by a respective modulator of the set of modulators 240B-1 through 240B-M. Each modulator can correspond to a respective channel 280B of a of a multichannel WDM system.

FIG. 2C is a diagram of an example system 200C, according to some embodiments. As shown, system 200C includes supplemental interconnect 140-1 of FIGS. 1A-1B.

System 200C can further include multiple optical wave sources including optical wave sources 210C-1 and 210C-2. More specifically, the optical wave sources can be external optical wave sources. In some embodiments, an optical wave source is an external laser source. The number of optical wave sources can be equal to N. Each of the optical wave sources can generate a respective wavelength of an optical wave.

System 200C includes power splitter 220C, and an additional set of power splitters including power splitter 225C-1 and power splitter 225C-2. The number of power splitters of the additional set of power splitters can be equal to N. System 200C further includes multiple sets of modulators including a first set of modulators 230C-1 through 230C-M and a final (N-th) set of modulators 240C-1 through 240C-M. The set of modulators 230B-1 through 230-M can correspond to a first wavelength of an optical wave (λ₁). The set of modulators 240B-1 through 240B-M can correspond to an N-th wavelength of an optical wave (λ_{N}). In some embodiments, power splitter 220B is integrated within supplemental interconnect 140-1, and the modulators are integrated within PIC 150.

Each optical wave source can be coupled to power splitter 220C. More specifically, each optical wave source can be connected to an optical fiber that is coupled to a waveguide that is connected to power splitter 220C. For example, optical fiber 260C, connected to optical wave source 210C-1, can be coupled to waveguide 270C, and waveguide 270C can be connected to power splitter 220C. Power splitter 220B can be an N-to-N splitter that generates N split waves from N optical waves received from the N optical wave sources including optical wave source 210B-1 and optical wave source 210B-2.

Each power splitter of the set of additional power splitters can receive a respective split wave of the N split waves from the power splitter 220C. For example, a first split wave can be received by power splitter 225C-1 and a second split wave can be received by power splitter 225C-2. Each power splitter of the set of additional power splitters can be a 1-to-M/N splitter that generates M/N split waves from the respective split wave received from power splitter 220C.

Each of the M/N split waves generated by a respective power splitter of the set of additional power splitters can be received by a respective modulator. More specifically, each set of modulators 230C-1 through 230C-M and 240C-1 through 240C-M can be divided into N subsets, where each subset includes M/N modulators. For example, as shown in FIG. 2C, a first subset of modulators of the set of modulators 230C-1 through 230C-M can include modulators 230C-1 through 230C-(M/N), a second subset of the set of modulators 230C-1 through 230C-M can include modulators 230C-(M/N+1) through 230C-(2M/N), etc. Moreover, a first subset of modulators of the set of modulators 240C-1 through 240C-M can include modulators 240C-1 through 240C-(M/N), a second subset of the set of modulators 240C-1 through 240C-M can include modulators 240C-(M/N+1) through 240C-(2M/N), etc. Each of the M/N split waves generated by power splitter 225C-1 can be received by a respective modulator of a subset of modulators. Each modulator can correspond to a respective channel 280C of a of a multichannel WDM system.

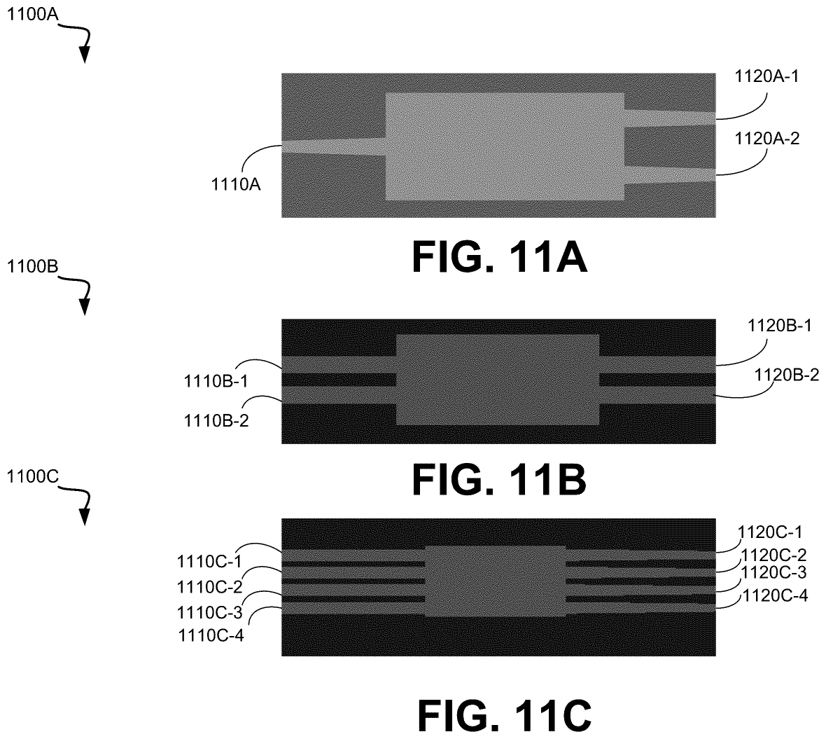

In some embodiments, power splitting and combining can be implemented by a single multimode interferometer (MMI). In some embodiments, power splitting and combining can be implemented by cascaded MMIs. Illustrative examples of MMIs are described below with reference to FIGS. 11A-11C.

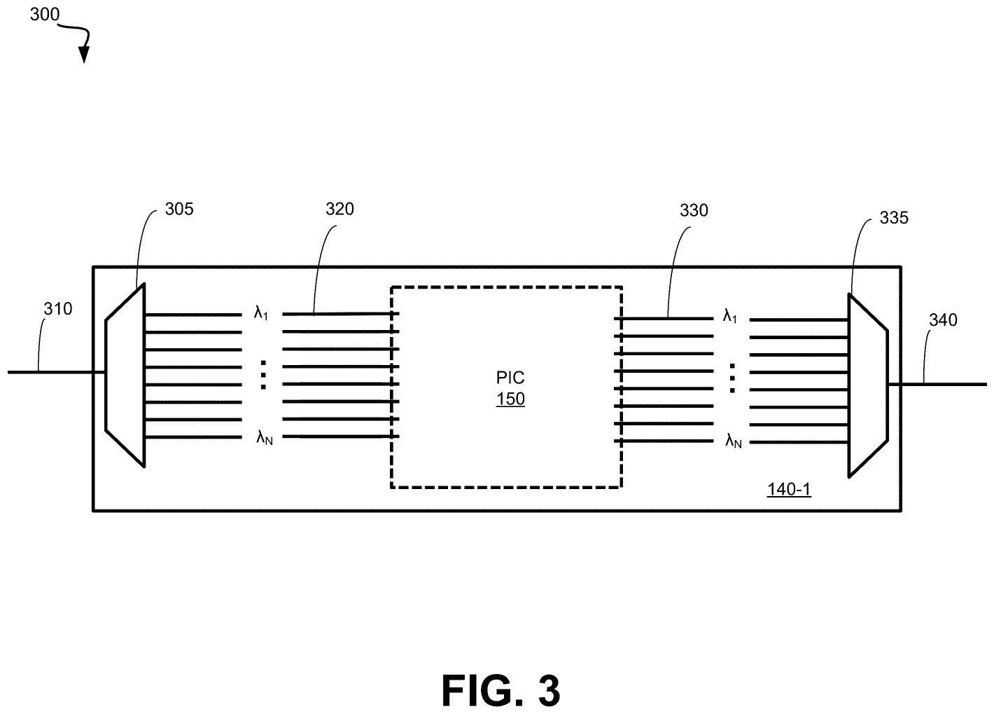

FIG. 3 is a diagram of an example system 300, according to some embodiments. As shown, system 300 includes supplemental interconnect 140-1 and PIC 150 of FIGS. 1A-2C. The system 300 can further include power splitter 305 (e.g., power splitter 210A-1 of FIG. 2A) that can receive input optical wave 310 (e.g., from optical wave generator 210A-1 of FIG. 2A). Power spitter 305 can generate, from input optical wave 310, N split waves 320, represented by λ₁ through λ_{N}, that are received by PIC 150. PIC 150 can generate N modulated waves 330, represented by λ₁ through λ_{N}, that are received by multiplexer 335 (e.g., multiplexer 250A-1 of FIG. 2A). Multiplexer 335 can generate modulated wave 340 from N modulated waves 330. Modulated wave 340 can correspond to a channel of a multichannel WDM system (e.g., channel 280A-1 of FIG. 2A).

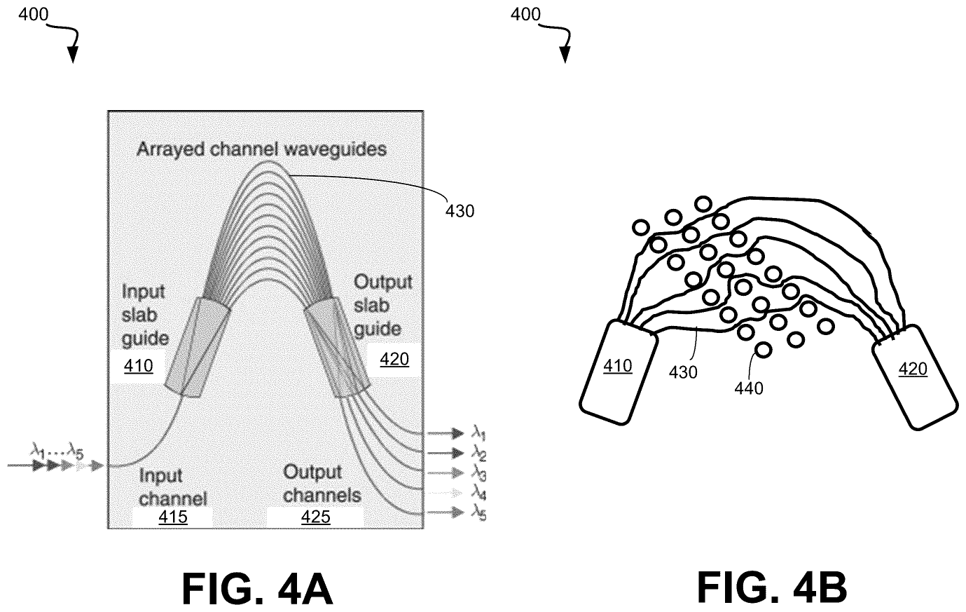

FIGS. 4A-4B are diagram of an example device 400, according to some embodiments. In some embodiments, device 400 is an interconnect (e.g., supplemental interconnect 140-1 of FIGS. 1-3). Device 400 can include input slab guide 410, output slab guide 420, and a set of arrayed channel waveguides 430. Device 400 can include input channel 415 to receive input optical waves within a single optical fiber. Device 400 can include output channels 425. Each channel 425 corresponds to a respective output optical wave. In some embodiments, as shown in FIG. 4B, device 400 includes multiple through vias 440, and the arrayed channel waveguides 430 are routed around through vias 440.

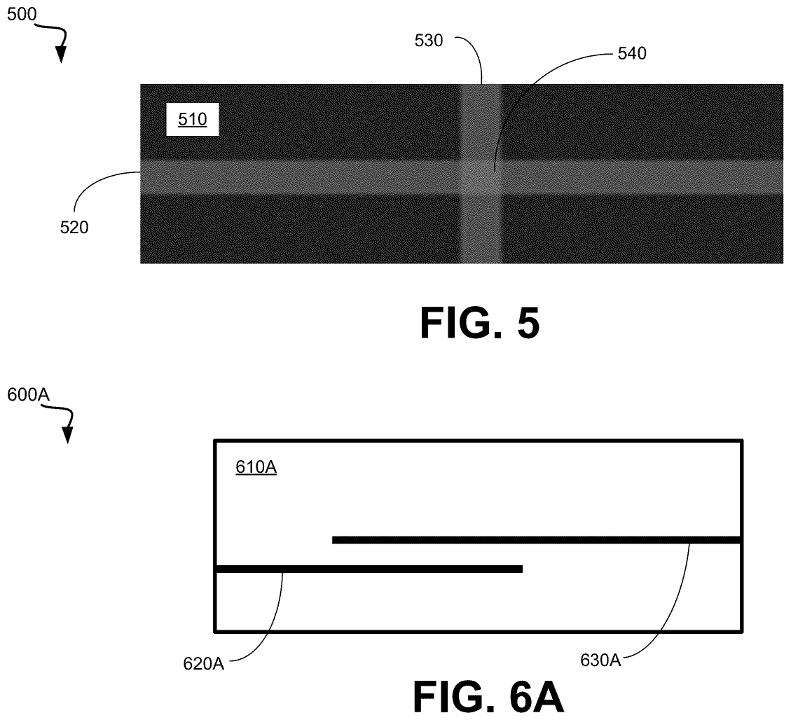

FIG. 5 is a diagram of a system 500 including a device implementing a 2D waveguide routing solution. More specifically, the device can include substrate 510 including waveguides 520 and 530 formed therein. Waveguides 520 and 530 can be formed on the same level and can cross at intersection 540. Insertion loss and cross-talk can be reduced to a sufficiently low amount by fine tuning the crossing dimensions.

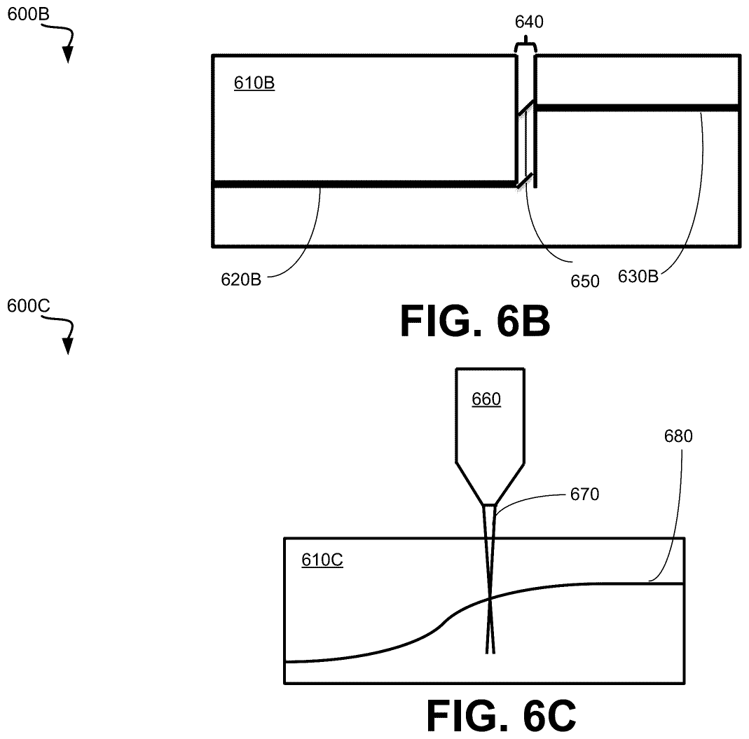

FIG. 6A is a diagram of a system 600A including a device implementing evanescent coupling 3D waveguide routing. More specifically, the device can include substrate 610A including waveguides 620A and 630A formed therein. Waveguide 620A corresponds to a first level and waveguide 630A corresponds to a second level above the first level. Evanescent coupling can be used to transmit an optical wave from waveguide 620A to waveguide 630A (or vice versa).

FIG. 6B is a diagram of a system 600B including a device implementing through via 3D waveguide routing. More specifically, the device can include substrate 610B including waveguides 620B and 630B formed therein. Waveguide 620B corresponds to a first level and waveguide 630B corresponds to a second level above the first level. The device can further include through via 640 formed within substrate 610B, and a set of routing elements 650 disposed within through via 640. An optical wave can be routed from waveguide 620B to waveguide 630B (or vice versa) using set of routing elements 650. For example, set of routing elements 650 can include a vertical waveguide, a set of optical elements (e.g., microlens, mirrors, meta-surfaces), etc.

FIG. 6C is a diagram of a system 600C including a device implementing direct waveguide writing 3D waveguide routing. More specifically, the device can include substrate 610C. System 600C can include optical wave generator (e.g., laser) 660 that can generate optical wave (e.g., laser beam) 670 that can directly write waveguide 680 inside of substrate 610C. Waveguide 680 can traverse a first level and a second level (e.g., similar to the first and second levels of FIGS. 6A-6B) to enable 3D waveguide routing.

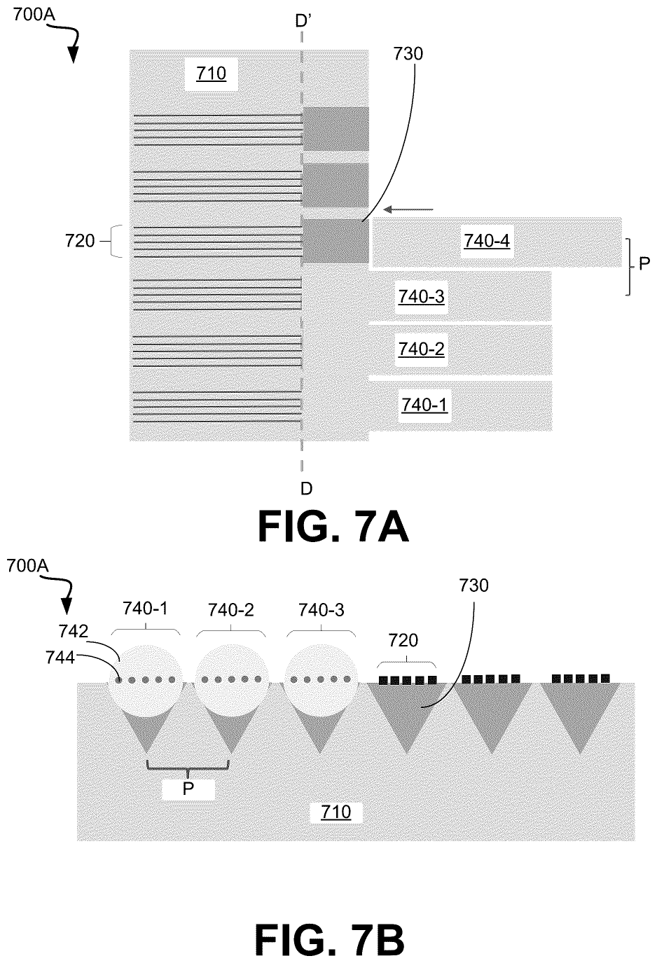

FIGS. 7A-7B are diagrams of views of an apparatus or system 700, according to some embodiments. More specifically, FIG. 7A is a top-down view of the system 700, and FIG. 7B is a cross-sectional view of the system 700 through line D-D′.

As shown in FIGS. 7A-7B, system 700 can include substrate 710 (e.g., corresponding to supplemental interconnect 140-1 of FIGS. 1-3), multiple sets of waveguides including set of waveguides 720 formed within substrate 710, and multiple grooves including groove 730 formed within substrate 710. In some embodiments, and as shown, groove 730 is a V-groove. Each set of waveguides can correspond to a respective groove (e.g., set of waveguides 720 corresponds to groove 730).

As further shown in FIGS. 7A-7B, system 700 can include multiple MC-SMF optical fibers including optical fibers 740-1 through 740-4. Each groove can receive a respective optical fiber, which can be secured with an adhesive (e.g., glue). For example, groove 730 can receive optical fiber 740-4. Each optical fiber can include a cladding layer and multiple inner cores disposed within the cladding layer. More specifically, each inner core can be a single-mode core. For example, optical fiber 740-1 includes cladding layer 742 and inner cores 744. Inner cores 744 can be arranged within cladding layer 742 using any suitable configuration or geometry. In these illustrative embodiments, inner cores 744 are arranged within cladding layer 742 in an approximately linear configuration. Each inner core 744 can be optically coupled to a respective waveguide of the corresponding set of waveguides.

The number of inner cores 744 that can be included in cladding layer 742 can depend at least in part on the diameter of the cladding layer 742 and the diameter of each inner core 744. In some embodiments, cladding layer 742 has a diameter that ranges between about 100 μm to about 150 μm. In some embodiments, cladding layer 742 has a diameter of about 125 μm. In these illustrative embodiments, each set of waveguides includes five waveguides and each optical fiber includes five inner cores. However, such an example should not be considered limiting. In some embodiments, up to seven inner cores can be linearly arranged within a cladding layer of an MC-SMF optical fiber.

In some embodiments, each inner core 744 has a diameter that ranges between about 6 μm to about 10 μm. In some embodiments, each inner core 744 has a diameter of about 8 μm. In some embodiments, a distance between each inner core 744 ranges between about 15 μm to about 25 μm. In some embodiments, a distance between each inner core 744 is about 20 μm.

In some embodiments, a pitch “P” corresponding to the distance between adjacent grooves (e.g., distance between points of adjacent V-grooves) ranges between about 100 μm to about 150 μm. In some embodiments, the pitch is about 127 μm. An effective pitch is defined as a ratio between the pitch and the number of inner cores within the pitch. For example, if the pitch is about 127 μm and the number of inner cores is five, then the effective pitch is about 25.4 μm.

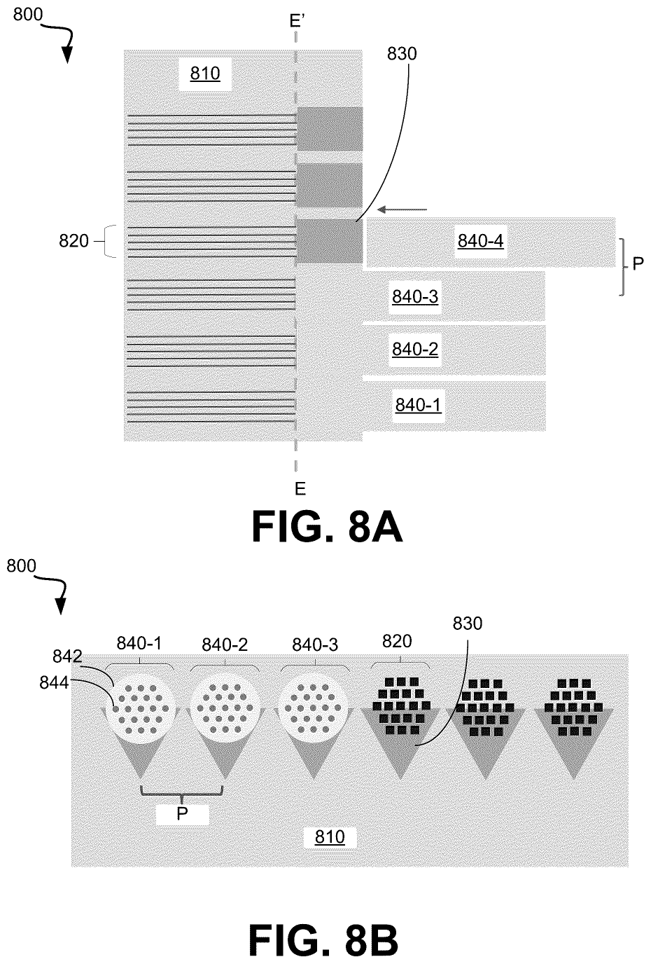

FIGS. 8A-8B are diagrams of views of an apparatus or system 800, according to some embodiments. More specifically, FIG. 8A is a top-down view of the system 800, and FIG. 8B is a cross-sectional view of the system 800 through line E-E′.

As shown in FIGS. 8A-8B, system 800 can include substrate 810 (e.g., corresponding to supplemental interconnect 140-1 of FIGS. 1-3), multiple sets of waveguides including set of waveguides 820 formed within substrate 810, and multiple grooves including groove 830 formed within substrate 810. In some embodiments, and as shown, groove 830 is a V-groove. Each set of waveguides can correspond to a respective groove (e.g., set of waveguides 820 corresponds to groove 830).

As further shown in FIGS. 8A-8B, system 800 can include multiple MC-SMF optical fibers including optical fibers 840-1 through 840-4. Each groove can receive a respective optical fiber, which can be secured with an adhesive (e.g., glue). For example, groove 830 can receive optical fiber 840-4. Each optical fiber can include a cladding layer and multiple inner cores disposed within the cladding layer. More specifically, each inner core can be a single-mode core. For example, optical fiber 840-1 includes cladding layer 842 and inner cores 844. Inner cores 844 can be arranged within cladding layer 842 using any suitable configuration or geometry. In these illustrative embodiments, inner cores 844 are arranged within cladding layer 842 in a non-linear configuration. For example, the non-linear configuration can have a hexagonal cross-sectional shape. Each inner core 844 can be optically coupled to a respective waveguide of the corresponding set of waveguides.

The number of inner cores 844 that can be included in cladding layer 842 can depend at least in part on the diameter of the cladding layer 842. In some embodiments, cladding layer 842 has a diameter that ranges between about 100 μm to about 150 μm. In some embodiments, cladding layer 842 has a diameter of about 125 μm. In these illustrative embodiments, each set of waveguides includes 19 waveguides and each optical fiber includes 19 inner cores. However, such an example should not be considered limiting. In some embodiments, up to 32 inner cores can be non-linearly arranged within a cladding layer of an MC-SMF optical fiber. In some embodiments, each inner core 844 has a diameter that ranges between about 6 μm to about 10 μm. In some embodiments, each inner core 844 has a diameter of about 8 μm.

In some embodiments, a pitch “P” corresponding to the distance between adjacent grooves (e.g., distance between points of adjacent V-grooves) ranges between about 100 μm to about 150 μm. In some embodiments, the pitch is about 127 μm. As previously mentioned above with reference to FIGS. 7A-7B, an effective pitch is defined as a ratio between the pitch and the number of inner cores within the pitch. For example, if the pitch is about 127 μm and the number of inner cores is 19, then the effective pitch is about 6.7 μm. Accordingly, arranging multiple inner cores in a non-linear configuration can increase the number of inner cores within the optical fiber, which enable a smaller effective pitch as compared to the linear configuration example shown in FIGS. 7A-7B.

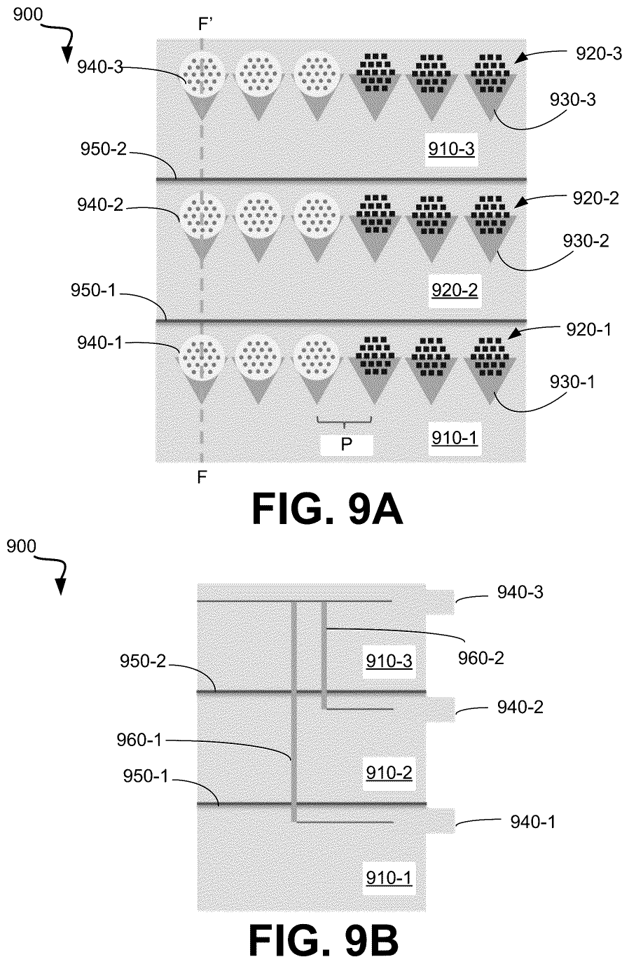

FIGS. 9A-9B are diagrams of views of an apparatus or system 900, according to some embodiments. More specifically, FIG. 9A is a cross-section view of the system 900, and FIG. 9B is a side view of the system 800 through line F-F′.

As shown in FIG. 9A, system 900 can include multiple substrates including substrates 910-1 through 910-3. Substrate 910-1 (e.g., corresponding to supplemental interconnect 140-1 of FIGS. 1-3) can include multiple sets of waveguides including set of waveguides 920-1 formed therein, and multiple grooves including groove 930-1 formed therein. Each groove of substrate 910-1 can receive a respective MC-SMF optical fiber (e.g., optical fiber 940-1), which can be secured with an adhesive (e.g., glue). Substrate 910-2 can include multiple sets of waveguides including set of waveguides 920-2 formed therein, and multiple grooves including groove 930-2 formed therein. Substrate 910-3 can include multiple sets of waveguides including set of waveguides 920-3 formed therein, and multiple grooves including groove 930-3 formed therein. Each groove of substrate 910-2 can receive a respective optical fiber (e.g., optical fiber 940-2), which can be secured with an adhesive (e.g., glue). Each groove of substrate 910-3 can receive a respective optical fiber (e.g., optical fiber 940-3), which can be secured with an adhesive (e.g., glue). Substrate 910-1 can be bonded to substrate 910-2 via bonding layer 950-1 and substrate 910-2 can be bonded to substrate 910-3 via bonding layer 950-2. In some embodiments, each groove is a V-groove. Each set of waveguides can correspond to a respective groove (e.g., set of waveguides 820 corresponds to groove 830). Each optical fiber can include a cladding layer and multiple inner cores disposed within the cladding layer. More specifically, each inner core can be a single-mode core. As shown in these illustrative embodiments, optical fiber 940-1 through 940-3 are similar to optical fibers 840-1 through 840-3 described above with reference to FIGS. 8A-8B (e.g., inner cores arranged within cladding layers in a non-linear configuration). However, such embodiments should not be considered limiting. In some embodiments, a pitch “P” corresponding to the distance between adjacent grooves (e.g., distance between points of adjacent V-grooves) ranges between about 100 μm to about 150 μm. In some embodiments, the pitch is about 127 μm (e.g., between about 2-3 μm effective, as compared to about 25 μm effective). Accordingly, bonding multiple substrates together can enable a smaller effective pitch as compared to the single substrate examples shown in FIGS. 7A-7B and FIGS. 8A-8B.

As further shown in FIG. 9B, multiple vias including vias 960-1 and 960-2 can be formed to route waveguides from one of substrates 910-1 through 910-3 to another one of substrate 910-1 through 910-3 with techniques such as photonic wire bonding, meta-lens, etc. In some embodiments, a via is a TGV.

An effective pitch for a system described herein can be determined based on a ratio between the pitch between grooves and the number of inner cores in an optical fiber. For example, in FIGS. 7A-7B, the effective pitch can be determined as the ratio of the pitch P and the number of inner cores in an optical fiber. Illustratively, if the pitch is 127 μm and the number of inner cores in optical fiber 740-1 is five, then the effective pitch is a about 25.4 μm. As another example, in FIGS. 8A-8B, the effective pitch can be determined as the ratio of the pitch P and the number of inner cores in an optical fiber. Illustratively, if the pitch is 127 μm and the number of inner cores in optical fiber 840-1 is 19, then the effective pitch is a about 6.7 μm. As yet another example, in FIGS. 9A-9B, the effective pitch can be determined as the ratio of the pitch P and the number of inner cores in an optical fiber, divided by the number of substrates. Illustratively, if the pitch is 127 μm and the number of inner cores in optical fiber 940-1 is 19, then the effective pitch is about 2.2 μm.

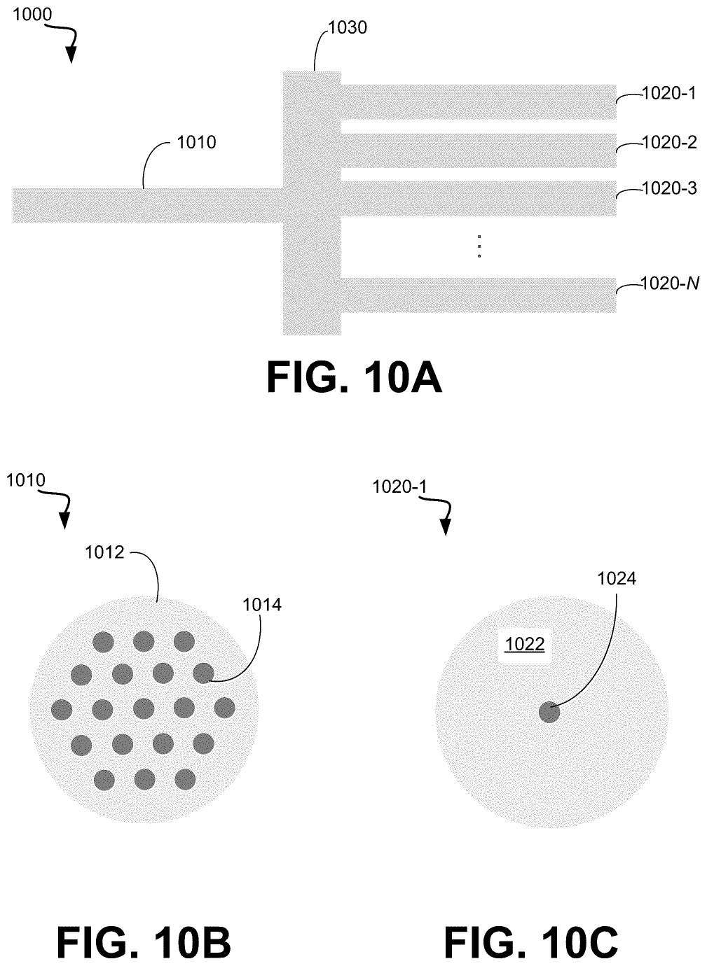

FIG. 10A is a diagram of a system 1000 enabling an MC-SMF to SMF connection, according to some embodiments. As shown, system 1000 can include MC-SMF optical fiber 1010 and multiple SMF optical fibers 1020-1 through 1020-N. MC-SMF optical fiber 1010 is attached (e.g., coupled) to a first end of MC-SMF to SMF connector (“connector”) 1030 and SMF optical fibers 1020-1 through 1020-N are attached (e.g., coupled) to a second end of connector 1030. MC-SMF optical fiber 1010 can be connected to multiple standard SMF optical fibers 1020-1 through 1020-N using any suitable connector 1030 for standard connection. An example of MC-SMF optical fiber 1010 including cladding layer 1012 and multiple inner cores 1014 is shown with reference to FIG. 10B (e.g., similar to MC-SMF optical fiber 840-1 of FIGS. 8A-8B). An example of SMF optical fiber 1020-1 including cladding layer 1022 and inner core 1024 is shown with reference to FIG. 10C.

FIG. 11A is a diagram of an example MMI 1100A, according to some embodiments. More specifically, the MMI 1100A is a 1×2 MMI. For example, as shown, the MMI 1100A can include a single input port 1110A and two output ports 1120A-1 and 1120A-2. Power of an optical wave received via the input port 1110A can be evenly split between the two output ports 1120A-1 and 1120A-2. Accordingly, cascading N MMIs 1100A can enable 2^{N} power splitting.

FIG. 11B is a diagram of an example MMI 1100B, according to some embodiments. More specifically, the MMI 1100B is a 2×2 MMI. For example, as shown, the MMI 1100B can include two input ports 1110B-1 and 1110B-2, and two output ports 1120B-1 and 1120B-2. Each of the input ports 1110B-1 and 1110B-2 can receive a respective wavelength of an optical wave, which can be combined into a combined wave. The combined power of the combined wave can be evenly split between the two output ports 1120B-1 and 1120B-2. Accordingly, cascading N MMIs 1100B can enable 2^{N} power splitting and WDM.

FIG. 11C is a diagram of an example MMI 1100C, according to some embodiments. More specifically, the MMI 1100C is a 2×2 MMI. For example, as shown, the MMI 1100B can include four input ports 1110C-1 through 1110C-4, and four output ports 1120B-1 through 1120B-4. Each of the input ports 1110C-1 and 1110C-4 can receive a respective wavelength of an optical wave, which can be combined into a combined wave. The combined power of the combined wave can be evenly split between the four output ports 1120B-1 through 1120B-4. Accordingly, MMI 1110C can achieve similar functionality as a 2×2 MMI (e.g., the MMI 1100B of FIG. 2B), with a more compact footprint.

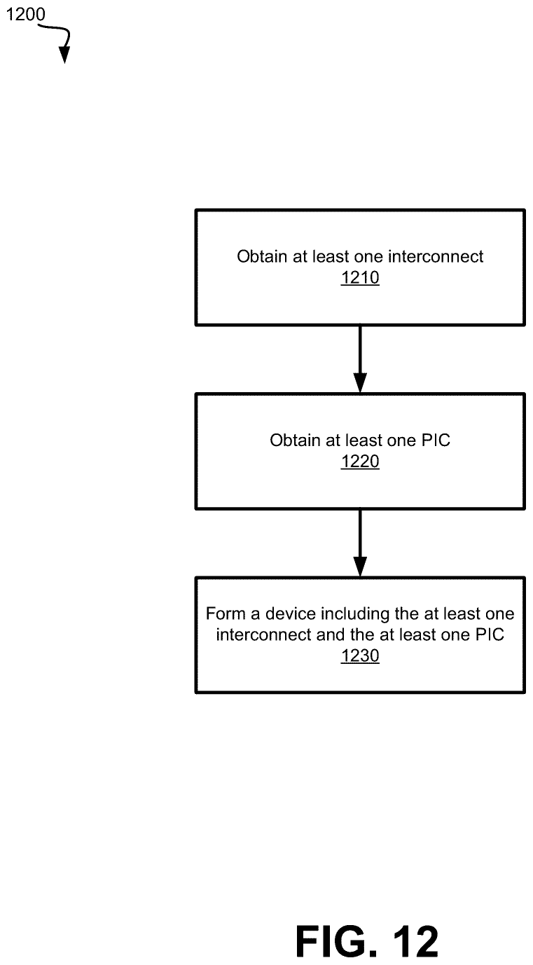

FIG. 12 is a flowchart of a method to enable offloading of photonic integrated circuit (PIC) functionality into an optical interconnect, according to some embodiments. At block 1210, at least one interconnect is obtained. The at least one interconnect can include a set of power splitters and a set of multiplexers. For example, the at least one interconnect can be similar to supplemental interconnect 140-1 of FIGS. 1A-3.

At block 1220, at least one PIC is obtained. The at least one PIC can include a set of modulators. For example, the at least one PIC can be similar to PIC 150 of FIGS. 1A-3.

At block 1230, a device including the at least one interconnect and the at least one PIC is formed. For example, the device can include a PCB (e.g., PCB 102 of FIGS. 1A-1B), a base interconnect formed on the PCB (e.g., base interconnect 105 of FIGS. 1A-1B), the at least one interconnect (as at least one supplemental interconnect) formed on the base interconnect, and the at least one PIC formed on the at least one interconnect. For example, a ball grid array can be disposed between the at least one interconnect and the at least one PIC. Further details regarding blocks 1210-1230 are described above with reference to FIGS. 1A-11C.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

As used herein, the singular forms “a,” “an,” and “the” include plural references unless the context clearly indicates otherwise. Thus, for example, reference to “a precursor” includes a single precursor as well as a mixture of two or more precursors; and reference to a “reactant” includes a single reactant as well as a mixture of two or more reactants, and the like.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%, such that “about 10” would include from 9 to 11.

The term “at least about” in connection with a measured quantity refers to the normal variations in the measured quantity, as expected by one of ordinary skill in the art in making the measurement and exercising a level of care commensurate with the objective of measurement and precisions of the measuring equipment and any quantities higher than that. In certain embodiments, the term “at least about” includes the recited number minus 10% and any quantity that is higher such that “at least about 10” would include 9 and anything greater than 9. This term can also be expressed as “about 10 or more.” Similarly, the term “less than about” typically includes the recited number plus 10% and any quantity that is lower such that “less than about 10” would include 11 and anything less than 11. This term can also be expressed as “about 10 or less.”

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to illuminate certain materials and methods and does not pose a limitation on scope. No language in the specification should be construed as indicating any non-claimed element as essential to the practice of the disclosed materials and methods.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A system comprising:
an interconnect comprising at least one power splitter; and
a photonic integrated circuit (PIC) disposed on the interconnect, the PIC comprising at least one set of modulators.

2. The system of claim 1, wherein the at least one power splitter is to receive at least one optical wave from at least one optical wave source.

3. The system of claim 1, wherein each modulator of the at least one set of modulators is to receive a respective output of the at least one power splitter.

4. The system of claim 1, wherein the interconnect further comprises a set of multiplexers, and wherein each multiplexer of the set of multiplexers is to receive a respective output of a respective modulator of the at least one set of modulators.

5. The system of claim 4, wherein each multiplexer of the set of multiplexers corresponds to a respective channel of a multichannel wavelength division multiplexing system.

6. The system of claim 1, wherein the interconnect comprises a set of arrayed channel waveguides.

7. The system of claim 6, wherein the set of arrayed channel waveguides is routed around a set of through vias.

8. The system of claim 1, wherein the interconnect implements two-dimensional (2D) waveguide routing.

9. The system of claim 1, wherein the interconnect implements three-dimensional (3D) waveguide routing.

10. The system of claim 9, wherein the 3D waveguide routing is one of:
evanescent coupling 3D waveguide routing;
through via 3D waveguide routing; or
direct waveguide writing 3D waveguide routing.

11. A method comprising:
obtaining at least one interconnect comprising at least one power splitter;
obtaining at least one photonic integrated circuit (PIC) comprising at least one set of modulators; and
forming a device comprising the at least one interconnect and the at least one PIC.

12. The method of claim 11, wherein the at least one power splitter is to receive at least one optical wave from at least one optical wave source.

13. The method of claim 11, wherein each modulator of the set of modulators is to receive a respective output of the at least one power splitter.

14. The method of claim 11, wherein the interconnect further comprises a set of multiplexers, and wherein each multiplexer of the set of multiplexers is to receive a respective output of a respective modulator of the at least one set of modulators.

15. The method of claim 14, wherein each multiplexer of the set of multiplexers corresponds to a respective channel of a multichannel wavelength division multiplexing system.

16. The method of claim 11, wherein the interconnect comprises a set of arrayed channel waveguides.

17. The method of claim 16, wherein the set of arrayed channel waveguides is routed around a set of through vias.

18. The method of claim 11, wherein the interconnect implements two-dimensional (2D) waveguide routing.

19. The method of claim 11, wherein the interconnect implements three-dimensional (3D) waveguide routing.

20. The method of claim 19, wherein the 3D waveguide routing is one of:
evanescent coupling 3D waveguide routing;
through via 3D waveguide routing; or
direct waveguide writing 3D waveguide routing.
